(19) United States
(12) Patent Application Publication
(10) Pub. No.: US 2023/0080398 A1
(43) Pub. Date: Mar. 16, 2023

(54) SENSING APPARATUS

(71) Applicant: InnoCare Optoelectronics Corporation, Tainan City (TW)

(72) Inventor: Yu-Heing Chen, Tainan City (TW)

(73) Assignee: InnoCare Optoelectronics Corporation, Tainan City (TW)

(21) Appl. No.: 17/888,498

(22) Filed: Aug. 16, 2022

(30) Foreign Application Priority Data
Sep. 14, 2021 (CN) 202111074824.X

(51) Int. Cl. G01T 1/20

(52) U.S. Cl. CPC G01T 1/20181; G01T 1/2002; G01T 1/2006

(57) ABSTRACT

The disclosure provides a first sensing device and a second sensing device. The second sensing device is disposed on the first sensing device, and each of the first sensing device and the second sensing device includes a substrate, a sensor array, and a scintillator layer. The sensor array is disposed on the substrate. The scintillator layer is disposed on the sensor array. A thickness of the scintillator layer of the second sensing device is greater than a thickness of the scintillator layer of the first sensing device.

### CROSS REFERENCE TO RELATED APPLICATION

This application claims the priority benefit of China Application serial No. 202111074824.X, filed on Sep. 14, 2021. The entirety of the above-mentioned patent application is hereby incorporated by reference herein and made a part of this specification.

### BACKGROUND

### Technical Field

The disclosure relates to a sensing apparatus; more particularly, the disclosure relates to a light sensing apparatus.

### Description of Related Art

A sensing apparatus (e.g., an x-ray sensing apparatus) may be applied to medical inspection imaging and/or non-destructive industrial inspection. In an exemplary x-ray sensing apparatus, when an X-ray passes through a to-be-sensed object, scattered X-rays are generated, which affects the accuracy of the sensed image. Accordingly, quality requirements for the sensing apparatus are increasing.

### SUMMARY

The disclosure provides a sensing apparatus which may improve resolution of sensed images.

According to an embodiment of the disclosure, a sensing apparatus includes a first sensing device and a second sensing device, the second sensing device is disposed on the first sensing device, and each of the first sensing device and the second sensing device includes a substrate, a sensor array, and a scintillator layer. The sensor array is disposed on the substrate. The scintillator layer is disposed on the sensor array. A thickness of the scintillator layer of the second sensing device is greater than a thickness of the scintillator layer of the first sensing device.

According to an embodiment of the disclosure, a sensing apparatus includes a first sensing device and a second sensing device, the second sensing device is disposed on the first sensing device, and each of the first sensing device and the second sensing device includes a substrate, a sensor array, and a scintillator layer. The sensor array is disposed on the substrate and includes a plurality of sensing units. The scintillator layer is disposed on the sensor array. A pitch between two adjacent sensing units of the sensing units of the first sensing device is less than a pitch between two adjacent sensing units of the sensing units of the second sensing device.

To make the abovementioned features and advantages of the disclosure more comprehensible, exemplary embodiments in concert with drawings are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and together with the description, serve to explain the principles of the disclosure.

FIG. 1 is a schematic view of a sensor array according to an embodiment of the disclosure.

FIG. 2 is a schematic view of an x-ray sensing apparatus according to an embodiment of the disclosure.

FIG. 3 is a schematic view of an x-ray sensing apparatus according to an embodiment of the disclosure.

FIG. 4 is a schematic view of an x-ray sensing apparatus according to an embodiment of the disclosure.

FIG. 5 is a schematic view of an x-ray sensing apparatus according to an embodiment of the disclosure.

FIG. 6 is a schematic view of an x-ray sensing apparatus according to an embodiment of the disclosure.

FIG. 7A schematically illustrates a sensing operation of an x-ray sensing apparatus according to an embodiment of the disclosure.

FIG. 7B schematically illustrates a method of processing a sensed image according to an embodiment of the disclosure.

FIG. 7C schematically illustrates a method of processing a sensed image according to an embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

Certain words are used to refer to specific elements in the entire specification and the appended claims of the disclosure. Persons skilled in the art should understand that electronic equipment manufacturers may use different names to refer to the same element. The text is not intended to distinguish elements that have the same function but different names. In the following specification and the appended claims, words such as “having” and “including” are open-ended words and therefore they should be interpreted as “including but not limited to...”.

Directional terms, such as “upper”, “lower”, “front”, “back”, “left”, and “right”, mentioned in the text refer to directions in the accompanying drawings. Therefore, the directional terms are used for illustration, and are not intended to limit the disclosure. It should be understood that when an element or a film layer is referred to as being “on” or “connected to” another element or film, the element or the film layer may be directly on or connected to the other element or film layer, or there may be an element or a film layer inserted between the two (in the case of being indirectly connected). Conversely, when an element or a film layer is referred to as being “directly on” or “directly connected to” another element or film layer, there is no element or film layer inserted between the two.

The terms “approximately”, “equal to”, “same as”, “similar to”, “substantially”, or “generally” mentioned in the text usually represent falling within a 10% range of a given numerical value or range, or represent falling within a of 5%, 3%, 2%, 1%, or 0.5% range of the given numerical value or range. In addition, phrases such as “a given range is a first numerical value to a second numerical value” and “a given range falls within a range of a first numerical value to a second numerical value” represent that the given range includes the first numerical value, the second numerical value, and other numerical values therebetween.

In some embodiments of the disclosure, terms related to bonding and connection, such as “connect” and “interconnect”, unless specifically defined, may mean that two structures are in direct contact, or may mean that two structures are not in direct contact, wherein there is another structure disposed between the two structures. The terms related to bonding and connection also include the cases where both structures are movable or both structures are fixed. In addition, the terms “electrically connected” and “coupled” include any direct and indirect means of electrical connection. In the case of direct connection, endpoints of elements on the two circuits are directly connected to each other or connected to each other by a conductor line segment; in the case of indirect connection, switches, diodes, capacitors, inductors, resistors, other appropriate elements, or a combination of said elements may exist between the endpoints of the elements on the two circuits, which should however not be construed as a limitation in the disclosure.

In the following embodiments, the same or similar element will adopt the same or similar reference numerals, and the repetition thereof will be omitted. In addition, the features in the embodiments may be used in any combination as long as they do not depart from the spirit of the disclosure or conflict with each other, and simple equivalent changes and modifications according to the specification or the appended claims shall still fall within the scope of the disclosure. Furthermore, the terms such as “first” and “second” mentioned in this specification or the appended claims are used to name different elements or to distinguish between different embodiments or ranges, and are not intended to limit the upper or lower limit of the number of elements and the manufacturing order or configuring order of the elements.

In this disclosure, measurements of thicknesses, lengths, and widths may be performed with use of an optical microscope, and the thicknesses may be further obtained by measuring a cross-sectional image in an electron microscope, which should however not be construed as a limitation in the disclosure. In addition, there may be a certain error in any two values or directions used for comparison. If the first value is equal to the second value, it implies that there may be an error of about 10%, 5%, or 3% between the first value and the second value.

Although the embodiments and advantages of the disclosure have been disclosed as above, it should be understood that people skilled in the art may make changes, replacements, and modifications without departing from the spirit and scope of the disclosure, and the features between the embodiments may be arbitrarily mixed and replaced to become other new embodiments.

The sensing apparatus provided in the disclosure may be applied to an x-ray sensing apparatus or a fingerprint identification apparatus, which should however not be construed as a limitation in the disclosure. In addition, the sensing apparatus includes a bendable and flexible sensing apparatus. The appearance of the sensing apparatus may be rectangular, circular, polygonal, have a with curved edges, or in other suitable shapes. The sensing apparatus may have peripheral systems, such as a driving system, a control system, a hierarchy system, and so on, so as to support the x-ray sensing apparatus or the fingerprint identification apparatus. Hereinafter, an x-ray sensing apparatus is applied to explain the content of this disclosure, which should however not be construed as a limitation to the disclosure.

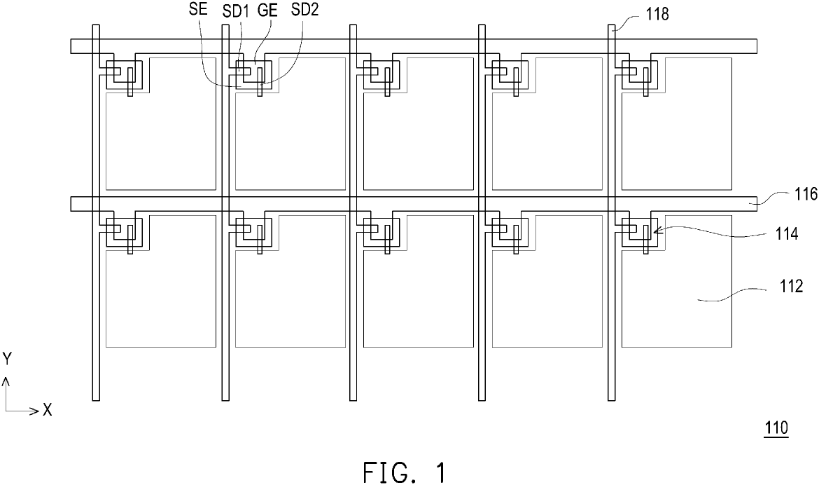

An embodiment of the disclosure provides an x-ray sensing apparatus that includes a first sensing device and a second sensing device. The second sensing device is disposed on the first sensing device. Each of the first sensing device and the second sensing device includes a substrate, a sensor array, and a scintillator layer. The sensor array is disposed on the substrate. The scintillator layer is disposed on the sensor array and may emit a light beam (e.g., a visible light beam) when irradiated by radiation or electromagnetic waves (e.g., an X-ray). Please refer to FIG. 1, which is a schematic view of a sensor array according to an embodiment of the disclosure. In FIG. 1, a sensor array 110 includes a plurality of sensing units 112, and the sensing units 112 may be arranged in an array on a plane in an X direction and a Y direction, which should however not be construed as a limitation in the disclosure. The sensor array 110 depicted in FIG. 1 may be applied to the x-ray sensing apparatus provided in each embodiment of the disclosure and may serve to read light signals and generate corresponding images according to intensity distribution of the light signals. In some embodiments, each sensing unit 112 may be a photo-sensitive element, such as a photodiode or the like. For instance, each sensing unit 112 may include a photodiode, and electrical signals of different magnitudes may be generated according to the intensity of incident visible light to fulfill the light sensing function. The photodiode may include an N-type semiconductor material, an intrinsic semiconductor material, and a P-type semiconductor material, which should however not be construed as a limitation in the disclosure. The sensor array 110 may also include a plurality of switch devices 114, a plurality of readout lines 118, and a plurality of scan lines 116. Each switch device 114 is, for instance, a transistor. The transistor includes a gate GE, a source SD1, a drain SD2, and a semiconductor SE, which should however not be construed as a limitation in the disclosure, and each switch device 114 is coupled between one of the sensing units 112 and the corresponding readout line 118 and scan line 116. Each scan line 116 may be coupled to the corresponding switch device 114 to control the switch device 114 to be turned on or off. In some embodiments, the sensing unit 112 may be the photodiode, one end of which may be coupled to a reference potential (e.g., a common potential), and the other end may be coupled to the switch device 114, which should however not be construed as a limitation in the disclosure. When the switch device 114 is subject to the control of the scan line 116 and is turned on, the electrical signal generated by the sensing unit 112 may be transmitted to the readout line 118 through the switch device 114. The readout line 118 may be coupled to a corresponding read circuit or a corresponding control circuit, and the read circuit or the control circuit may learn the intensity of light sensed by the sensing unit 112 according to the magnitude of the electrical signal.

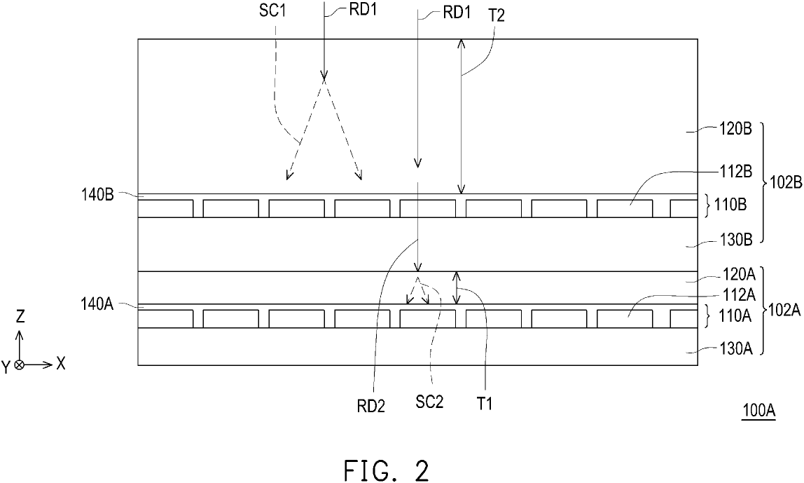

FIG. 2 is a schematic view of an x-ray sensing apparatus according to an embodiment of the disclosure, and FIG. 2 schematically illustrates a cross-section of the x-ray sensing apparatus. In FIG. 2, the x-ray sensing apparatus 100A includes a first sensing device 102A and a second sensing device 102B, and the second sensing device 102B is disposed on the first sensing device 102A. The first sensing device 102A includes a sensor array 110A, a scintillator layer 120A, and a substrate 130A. The sensor array 110A is disposed on the substrate 130A, and the scintillator layer 120A is disposed on the sensor array 110A. The structure of the second sensing device 102B is similar to the first sensing device 102A, and the second sensing device 102B includes a sensor array 110B, a scintillator layer 120B, and a substrate 130B. Here, the sensor array 110B is disposed on the substrate 130B, and the scintillator layer 120B is disposed on the sensor array 110B. In addition, the sensor array 110A of the first sensing device 102A may include an insulation layer 140A covering the sensing units 112A. The sensor array 110B of the second sensing device 102B may include an insulation layer 140B covering the sensing units 112B.

Here, the sensor array 110A and the sensor array 110B may be implemented in form of the sensor array 110 depicted in FIG. 1. For instance, each of the sensor array 110A and the sensor array 110B may be arranged by a plurality of sensing units 112 shown in FIG. 1, and each sensing unit 112 may be connected to the corresponding switch device 114. In other words, each of the sensor array 110A and the sensor array 110B may further include the switch device 114, the scan line 116, and the readout line 118 shown in FIG. 1. The sensing units 112A of the sensor array 110A and the sensing units 112B of the sensor array 110B may be designed to have the same layout density and may occupy the same area (e.g., the same sensing area), which should however not be construed as a limitation in the disclosure. In some embodiments, the sensing units 112A of the sensor array 110A and the sensing units 112B of the sensor array 110B may have different layout densities and/or occupy different areas. In other words, the resolution of the sensing units of the first sensing device 102A may be the same as or different from the resolution of the sensing units of the second sensing device 102B.

Each of the scintillator layer 120A and the scintillator layer 120B includes a light emitting material, e.g., a material that emits a light beam after it is irradiated by radiation. The materials of the scintillator layer 120A and the scintillator layer 120B may include organic light emitting materials, inorganic light emitting materials, or other materials of similar properties, which should however not be construed as a limitation in the disclosure. The inorganic light emitting material may include sodium iodide (NaI), cesium iodide (CsI), gadolinium oxysulfide (Gd₂O₂S), cadmium tungstate (CdWO₄), bismuth germanium oxide (BGO), glass, and so on. The organic light emitting material includes organic crystal, such as anthracene, stilbene, plastic scintillator, or the like, which should however not be construed as a limitation in the disclosure.

The substrate 130A of the first sensing device 102A and the substrate 130B of the second sensing device may each be a rigid substrate or a flexible substrate. A material of the rigid substrate may include glass, quartz, other appropriate materials, or a combination of the above materials, which should however not be construed as a limitation in the disclosure. A material of the flexible substrate may include polyimide (PI), polyethylene terephthalate (PET), a single-layer structure or a multi-layer structure of one of other appropriate materials, a stack or a mixture of at least two of the above materials, or a combination of one of the above materials and an insulation layer (e.g., an inorganic insulation layer) stacked in an alternate manner, which should however not be construed as a limitation in the disclosure. In some embodiments, at least one of the substrate 130A of the first sensing device 102A and the substrate 130B of the second sensing device is a rigid substrate, which may provide a favorable mechanical support. In some embodiments, at least one of the substrate 130A of the first sensing device 102A and the substrate 130B of the second sensing device is a flexible substrate. Since the thickness of the flexible substrate is less than the thickness of the rigid substrate, the overall thickness of the x-ray sensing apparatus may be reduced.

The insulation layer 140A of the first sensing device 102A and the insulation layer 140B of the second sensing device 102B may include oxides, nitrides, oxynitrides, organic insulation layers, or a stack or a mixture of at least two of the above materials, which should however not be construed as a limitation in the disclosure.

The x-ray sensing apparatus 100A may serve to sense radiation RD1 from the outside. Here, a wavelength of the radiation RD1, for instance, falls within the X-ray wavelength range (e.g., between 0.01 nanometers and 10 nanometers) or a wavelength range where energy is sufficient to excite the scintillator layer 102A or the scintillator layer 102B. Specifically, the radiation RD1 from the outside irradiates the scintillator layer 120B of the second sensing device 102B located on the first sensing device 102A to excite a light beam SC1; here, a wavelength of the light beam SC1 falls in the visible light range or the wavelength range that can be sensed by the sensing units 112B, for instance. Thereby, the sensing units 112B in the sensor array 110B may generate corresponding electrical signals in response to the magnitude of energy of the light beam SC1, and can sense the radiation RD1.

The radiation RD1 may be converted into the corresponding electrical signal in the second sensing device 102B. However, if the energy of the radiation RD1 is high, a portion of radiation RD2 of the radiation RD1 moves toward the first sensing device 102A. The first sensing device 102A may provide a sensing function similar to that of the second sensing device 102B. For instance, the radiation RD2 irradiates the scintillator layer 120A of the first sensing device 102A to excite a light beam SC2. As such, the sensing units 112A in the sensor array 110A may receive the light beam SC2 and generate the corresponding electrical signals to sense the light beam SC2. Accordingly, the sensing result of the first sensing device 102A is conducive to improvement of the sensing capability of the x-ray sensing apparatus 100A.

The first sensing device 102A and the second sensing device 102B may have different designs. For instance, a thickness T2 of the scintillator layer 120B of the second sensing device 102B may be different from a thickness T1 of the scintillator layer 120A of the first sensing device 102A. In some embodiments, the thickness T2 of the scintillator layer 120B of the second sensing device 102B may be measured in anywhere on the scintillator layer 120B in a normal direction parallel to the substrate 130B (e.g., the Z direction), and the thickness T1 of the scintillator layer 120A of the first sensing device 102A may be measured in anywhere on the scintillator layer 120A in the normal direction parallel to the substrate 130A (e.g., the Z direction). In some embodiments, the thickness T2 of the scintillator layer 120B of the second sensing device 102B may be greater than the thickness T1 of the scintillator layer 120A of the first sensing device 102A. For instance, when the scintillator layer 120A and scintillator layer 120B are made of cesium iodide, the thickness T1 may fall within a range from 50 microns to 400 microns, and the thickness T2 may fall within a range from 300 microns to 700 microns, which should however not be construed as a limitation in the disclosure. When the scintillator layer 120A and the scintillator layer 120B are made of gadolinium oxysulfide (GOS), the thickness T1 may fall within a range from 50 microns to 150 microns, and the thickness T2 may fall within a range from 100 microns to 350 microns, which should however not be construed as a limitation in the disclosure.

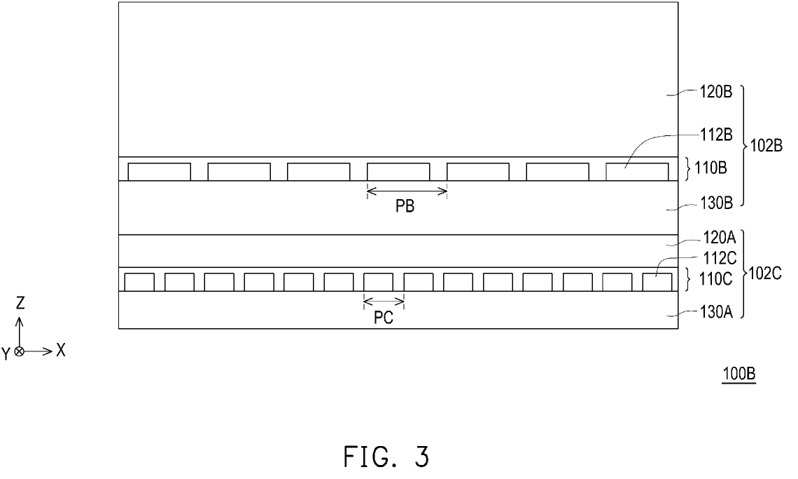

FIG. 3 is a schematic view of an x-ray sensing apparatus according to an embodiment of the disclosure. Here, an x-ray sensing apparatus 100B depicted in FIG. 3 is substantially similar to the x-ray sensing apparatus 100A depicted in FIG. 2, and the descriptions of the same components in one embodiment may serve as a cross-reference to the other. Specifically, in FIG. 3, the x-ray sensing apparatus 100B includes a first sensing device 102C and the second sensing device 102B, the first sensing device 102C includes a sensor array 110C, the scintillator layer 120A, and the substrate 130A, and the second sensing device 102B includes the sensor array 110B, the scintillator layer 120B, and the substrate 130B. In this embodiment, the overall second sensing device 102B, the first scintillator layer 120A, and the substrate 130A may refer to those provided in the previous embodiment and will not be further described hereinafter. The main difference between this embodiment and the embodiment depicted in FIG. 2 lies in the layout design of the sensor array 110C. In the x-ray sensing apparatus 100B, a pitch of two adjacent sensing units 112C in the sensor array 110C of the first sensing device 102C is smaller than a pitch of two adjacent sensing units 112B of the second sensing device 102B; therefore, in the first sensing device 102C, a pitch PC of the sensing units 112C in the X direction may be smaller than a pitch PB of the sensing units 112B in the X direction in the second sensing device 102B. For instance, in the X direction, the pitch PB of the sensing units 112B in the second sensing device 102B may be approximately twice the pitch PC of the sensing units 112C in the X direction in the first sensing device 102C, which should however not be construed as a limitation in the disclosure. The pitch PB refers to the minimum distance from one side of one of the two adjacent sensing units 112B in the X direction to the same side of the other sensing unit 112B (e.g., as shown in FIG. 3, from the left to the left, from the right to the right, or from the middle to the middle of two adjacent sensing units 112B). The pitch PC refers to the minimum distance from one side of one of the two adjacent sensing units 112C in the X direction to the same side of the other sensing unit 112C (e.g., as shown in FIG. 3, from the left to the left, from the right to the right, or from the middle to the middle of two adjacent sensing units 112C). Here, the pitch PB may be twice the pitch PC, so that two sensing units 112C correspond to one sensing unit 112B; therefore, the resolution of the sensing units 112C (the number of the sensing units per unit area) is greater than the resolution of the sensing units 112B, which should however not be construed as a limitation in the disclosure.

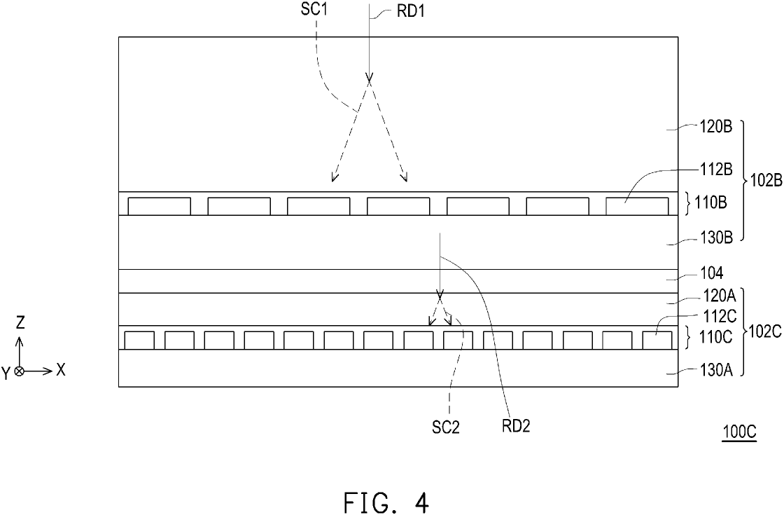

FIG. 4 is a schematic view of an x-ray sensing apparatus according to an embodiment of the disclosure. An x-ray sensing apparatus 100C depicted in FIG. 4 includes the first sensing device 102C and the second sensing device 102B illustrated in FIG. 3 and further includes a light shielding layer 104. The description of the first sensing device 102C and the second sensing device 102B may refer to the description provided in the previous embodiment and will not be repeated hereinafter. The light shielding layer 104 is disposed between the first sensing device 102C and the second sensing device 102B. The light shielding layer 104 may help prevent the visible light beam generated by the second sensing device 102B or an external visible light beam from irradiating the sensing units 112C of the first sensing device 102C, so as to mitigate the interference of the second sensing device 102B with the first sensing device 102C. Since the light shielding layer 104 does not block the radiation, when the energy of the radiation RD1 is intense, a portion of the radiation RD1 may be converted into the light beam SC1 in the second sensing device 102B, and the radiation RD2 that is not converted in the second sensing device 102B continues to move toward the first sensing device 102C. In this embodiment, the light shielding layer 104 may help prevent the light beam SC1 from entering the first sensing device 102C or may block the light beam SC1 from entering the first sensing device 102C, the light shielding layer 104 does not block the radiation RD2 or may allow a significant portion of the radiation RD2 to enter the first sensing device 102C. Therefore, the radiation RD2 may enter the first sensing device 102C and may be converted into the light beam SC2 in the first sensing device 102C, and the light shielding layer 104 may also help prevent or block the light beam SC2 from entering the second sensing device 102B. In some embodiments, a material of the light shielding layer 104 may include an opaque metallic material (such as aluminum), black resin, any other similar material, or a combination of the above-mentioned materials, which should however not be construed as a limitation in the disclosure. In addition, the light shielding layer 104 may also be applied to the x-ray sensing apparatus 100A depicted in FIG. 2 and may be disposed between the first sensing device 102A and the second sensing device 102B.

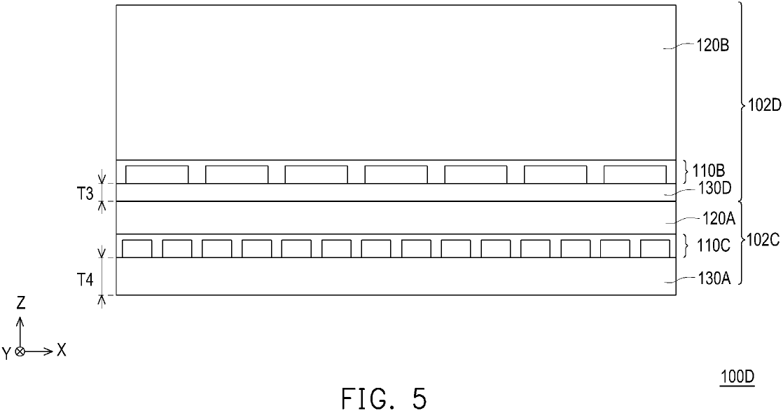

FIG. 5 is a schematic view of an x-ray sensing apparatus according to an embodiment of the disclosure. An x-ray sensing apparatus 100D depicted in FIG. 5 includes the first sensing device 102C and a second sensing device 102D disposed on the first sensing device 102C, and the first sensing device 102C is substantially the same as the first sensing device 102C in FIG. 3 and thus will not be further described hereinafter. Specifically, the second sensing device 102D includes the sensor array 110B, the scintillator layer 120B, and a substrate 130D. Here, the structures, the materials, the configurations, and the functions of the sensor array 110C, the scintillator layer 120A, the substrate 130A, the sensor array 110B, and the scintillator layer 120B may refer to those provided in the previous embodiments and thus will not be further described hereinafter. In this embodiment, the substrate 130D may be a flexible substrate, and the material and the structure may be the same as or similar to those described above and thus are not further described hereinafter. In addition, a thickness T3 of the substrate 130D in the Z direction at anywhere on the substrate 130D may be different from a thickness T4 of the substrate 130A in the Z direction at anywhere on the substrate 130A. In some embodiments, the thickness T3 is less than or equal to the thickness T4, and in other embodiments, the thickness T3 is greater than the thickness T4.

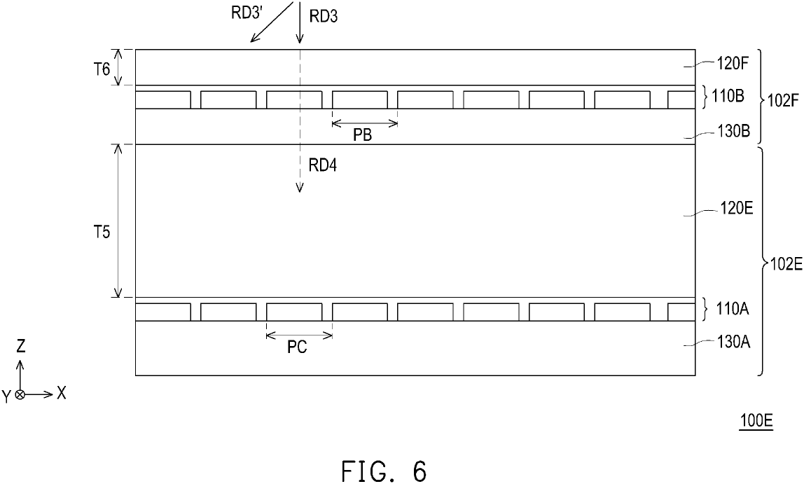

FIG. 6 is a schematic view of an x-ray sensing apparatus according to an embodiment of the disclosure. An x-ray sensing apparatus 100E depicted in FIG. 6 includes a first sensing device 102E and a second sensing device 102F disposed on the first sensing device 102E. Specifically, the first sensing device 102E includes the sensor array 110A, a scintillator layer 120E, and the substrate 130A, and the second sensing device 102F includes the sensor array 110B, a scintillator layer 120F, and the substrate 130B. Here, the structures, the materials, the configurations, and the functions of the sensor array 110A, the scintillator layer 120E, the substrate 130A, the sensor array 110B, the scintillator layer 120F, and the substrate 130B may refer to those provided in the previous embodiments and thus will not be further described hereinafter. In this embodiment, a thickness T5 of the scintillator layer 120E in the Z direction at anywhere on the scintillator layer 120E may be greater than a thickness T6 of the scintillator layer 120F in the Z direction at anywhere on the scintillator layer 120F. In some embodiments, the pitch PC of two adjacent sensing units of the sensor array 110A of the first sensing device 102E may be less than or equal to the pitch PB of two adjacent sensing units of the sensor array 110B of the second sensing device 102F.

In this embodiment, the second sensing device 102F on the first sensing device 102E has the relatively thin scintillator layer 120F. When the x-ray sensing apparatus 100E performs the sensing operation, one portion of radiation (radiation RD3) with relatively intense energy from the outside irradiates the scintillator layer 120F, while the other portion of radiation (radiation RD4) which is not absorbed by the scintillator layer 120F enters the scintillator layer 120E of the first sensing device 102E. In some embodiments, stray radiation RD3', e.g., scattered radiation generated during the sensing process, exists on the outside. Since the stray radiation RD3' has a low energy intensity, it may be completely converted into a light beam by the scintillator layer 120F of the second sensing device 102F and cannot enter the scintillator layer 120E of the first sensing device 102E. Therefore, the second sensing device 102F on the first sensing device 102E has the relatively thin scintillator layer 120F that may filter out the stray radiation RD3', so that the radiation RD4 received by the first sensing device 102E may provide favorable sensing information.

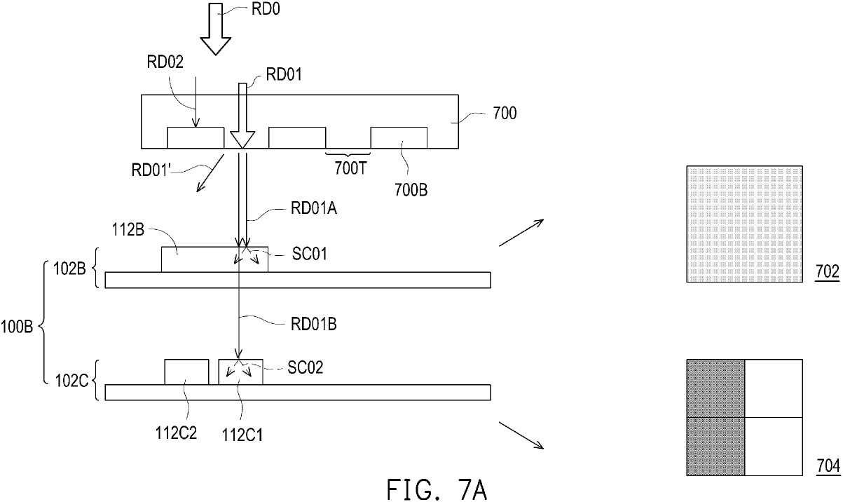

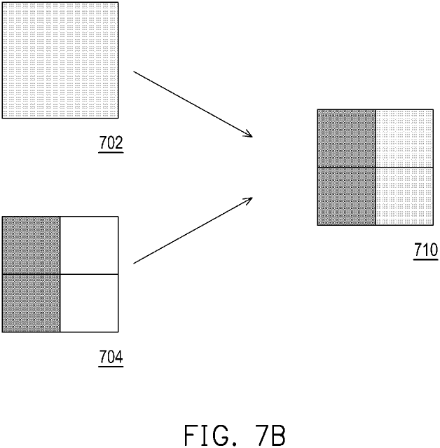

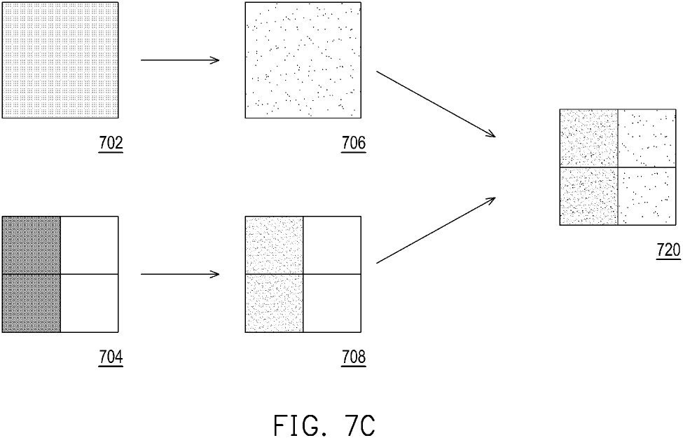

FIG. 7A illustrates a sensing operation of an x-ray sensing apparatus according to an embodiment of the disclosure. Here, FIG. 7A, for instance, serves to illustrate the sensing operation of the x-ray sensing apparatus 100B depicted in FIG. 3, and thus the descriptions of the specific components and the design of the x-ray sensing apparatus 100B may refer to relevant descriptions as shown in FIG. 3. In FIG. 7A, a to-be-sensed object 700 is located on one side of the x-ray sensing apparatus 100B. During the sensing operation, radiation RD0 may be provided to irradiate toward the to-be-sensed object 700, the x-ray sensing apparatus 100B is disposed in an irradiation direction of the radiation RD0, and the second sensing device 102B is located between the first sensing device 102C and the to-be-sensed object 700. The to-be-sensed object 700 includes a blocking region 700B that may block the radiation RD0 and a transmitting region 700T that may allow the radiation RD0 to pass through. The radiation RD0includes radiation RD01 and radiation RD02. The radiation RD01 irradiates the transmitting region 700T and may pass through the to-be-sensed object 700 and irradiates the x-ray sensing apparatus 100B, while the radiation RD02 irradiates the blocking region 700B and cannot pass through to-be-sensed object 700.

At least one portion of the radiation RD01 (i.e., radiation RD01A) is converted into a light beam SC01 by the scintillator layer in the second sensing device 102B and sensed by the sensing units at corresponding locations in the second sensing device 102B. Thereby, in the second sensing device 102B, the sensing units corresponding to the blocking region 700B of the to-be-sensed object 700 do not sense the light signals, while the sensing units corresponding to the transmitting region 700T of the to-be-sensed object 700 may sense the light signals. The second sensing device 102B may obtain a sensed image 702 according to the intensity of the sensed light signals.

In addition, the other portion of the radiation RD01 (i.e., radiation RD01B) which is not converted into the light beam SC01 by the scintillator layer in the second sensing device 102B passes through the second sensing device 102B and irradiates the first sensing device 102C. The radiation RD01B is converted into a light beam SC02 by the scintillator layer in the first sensing device 102C and sensed by the sensing units in the first sensing device 102C, thereby obtaining a sensed image 704. In this embodiment, the pitch of two adjacent sensing units in the first sensing device 102C is different from the pitch of two adjacent sensing units in the second sensing device 102B; for instance, the pitch of two adjacent sensing units of the sensing units 112B of the second sensing device 102B may be approximately twice the pitch of adjacent sensing units 112C1 and 112C2 in the first sensing device 102C. Therefore, the sensed image 702 and the sensed image 704 may have different resolutions, which should however not be construed as a limitation in the disclosure. The sensing units 112B in the second sensing device 102B includes one portion corresponding to the transmitting region 700T and the other portion corresponding to the blocking region 700B, wherein the portion corresponding to the transmitting region 700T may sense the light beam, while the other portion corresponding to the blocking region 700B cannot sense the light beam. For instance, half of the sensing units 112B in the second sensing device 102B may sense the light beam, and the other half cannot sense the light beam. Therefore, sensing results of the sensing units 112B in the second sensing device 102B may be the sum of the two portions (e.g., the sensing results of the two portions are averaged). In the first sensing device 102C, one sensing unit 112C1 substantially corresponds to the transmitting region 700T, and the other sensing unit 112C2 substantially corresponds to the blocking region 700B; here, the sensing unit 112C1 of the first sensing device 102C corresponding to the transmitting region 700T may sense the light beam, while the sensing unit 112C2 of the first sensing device 102C corresponding to the blocking region 700B cannot sense the light beam.

In some embodiments, the radiation RD0may be scattered and/or refracted when passing through to-be-sensed object 700; although the scattered and/or refracted stray radiation RD01' have low energy, the scattered and/or refracted stray radiation RD01' may still be sensed by the second sensing device 102B after irradiating the second sensing device 102B. Therefore, the sensed image 702 may contain information of the stray radiation RD01' (e.g., such as spurious information). However, due to the low energy of the stray radiation RD01', the stray radiation RD01' may almost be completely absorbed and converted into the light beam in the second sensing device 102B. Therefore, the probability of the stray radiation RD01' entering the first sensing device 102C is reduced. Thereby, the sensed image 704 measured by the first sensing device 102C may serve to assist in correcting the spurious information generated by the stray radiation RD01' in the sensed image 702. In other words, the design of stacking two sensing devices in the x-ray sensing apparatus 100B may improve the quality of the sensed image or reduce the spurious information in the sensed image.

In addition, the first sensing device 102C has a structure as shown in FIG. 3, the scintillator layer in the first sensing device 102C is thinner than the scintillator layer in the second sensing device 102B, and the pitch of the adjacent sensing units in the first sensing device 102C is smaller than the pitch of the adjacent sensing units in the second sensing device 102B. Under such a configuration, the resolution of the sensed image 704 obtained by the first sensing device 102C is different from the resolution of the sensed image 702 obtained by the second sensing device 102B, which should however not be construed as a limitation in the disclosure.

FIG. 7B illustrates a method of processing a sensed image according to an embodiment of the disclosure. As illustrated in FIG. 7A, the sensed image 702 may include spurious information corresponding to the stray radiation RD01'. In addition, the sensed image 704 reflects the information of the radiation RD01B which is not absorbed by the second sensing device 102B but does not fully reflect the actual situation of the to-be-sensed object 700. Therefore, according to the embodiment depicted in FIG. 7B, the sensed image 702 and the sensed image 704 generated in the manner shown in FIG. 7A may be synthesized by means of calculation of computing devices, so as to obtain a synthesized sensed image 710. The synthesized sensed image 710 may lessen the influence of spurious information in the sensed image 702, so that the synthesized sensed image 710 may improve the sensing quality.

FIG. 7C illustrates a method of processing a sensed image according to an embodiment of the disclosure. The method of processing the sensed image illustrated in FIG. 7C is substantially similar to the method illustrated in FIG. 7B, while an image processing operation is performed in FIG. 7C before the sensed image 702 and the sensed image 704 are synthesized. The sensed image 702 may be pre-processed to generate a processed image 706, and the sensed image 704 may be pre-processed to generate a processed image 708. The preprocessing operation may be performed in response to different needs, including various processing techniques such as noise reduction, quantization, and sharpening. After the preprocessing operation is performed, the processed image 706 and the processed image 708 are synthesized into a synthesized sensed image 720. In some embodiments, individual pixel information of the synthesized sensed image 720 may be obtained by the following formula: P₇₂₀=A*f(P₇₀₂)+B*g(P₇₀₄), where P720 is image information of the synthesized sensed image 720, P702 is image information of the sensed image 702, P704 is image information of the sensed image 704, f and g are image processing functions (e.g., a convolution filter), and A and B are real numbers. The sensing operations and the image processing methods illustrated in FIG. 7A to FIG. 7C may be applied to any of the x-ray sensing apparatuses 100A to 100E and are not limited to be applied in the x-ray sensing apparatus 100B.

To sum up, in the sensing apparatus provided in one or more embodiments of the disclosure, two sensing devices are stacked, so as to obtain a favorable sensed image by performing dual-sensing operations. As such, the sensing apparatus may improve the quality of the sensed image and enhance the sensing capability. The stacked sensing devices may have different structural designs and different resolutions. Therefore, the sensing apparatus may provide ideal sensing capabilities. When the sensing apparatus is applied to the field of medical images, even if the radiation dose is limited in view of safety considerations, satisfactory sensed images may be obtained. Compared with the sensing apparatus with a single-layer sensing device, the sensing apparatus provided in one or more embodiments of the disclosure may resolve the conventional issue of not being able to improve the resolution of the sensed image.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A sensing apparatus, comprising:
a first sensing device and a second sensing device, wherein the second sensing device is disposed on the first sensing device, each of the first sensing device and the second sensing device comprises a first sensing device and a second sensing device disposed on the first sensing device, and each of the first sensing device and the second sensing device comprises:
a substrate;
a sensor array, disposed on the substrate; and
a scintillator layer, disposed on the sensor array,
wherein a thickness of the scintillator layer of the second sensing device is greater than a thickness of the scintillator layer of the first sensing device.

2. The sensing apparatus according to claim 1, wherein the sensor array of the first sensing device comprises a plurality of sensing units, the sensor array of the second sensing device comprises a plurality of sensing units, and a pitch between two adjacent sensing units of the plurality of sensing units of the first sensing device is less than or equal to a pitch between two adjacent sensing units of the plurality of sensing units of the second sensing device.

3. The sensing apparatus according to claim 2, wherein the sensor array of the first sensing device further comprises a switch device coupled to one of the plurality of sensing units of the first sensing device.

4. The sensing apparatus according to claim 2, wherein the sensor array of the second sensing device further comprises a switch device coupled to one of the plurality of sensing units of the second sensing device.

5. The sensing apparatus according to claim 1, further comprising a light shielding layer disposed between the first sensing device and the second sensing device.

6. The sensing apparatus according to claim 5, wherein a material of the light shielding layer comprises aluminum.

7. The sensing apparatus according to claim 1, wherein at least one of the substrate of the first sensing device and the substrate of the second sensing device is a flexible substrate.

8. The sensing apparatus according to claim 1, wherein the sensor array of each of the first sensing device and the second sensing device comprises a plurality of sensing units, and the plurality of sensing units comprises photodiodes.

9. The sensing apparatus according to claim 1, wherein the scintillator layer comprises an organic light emitting material, an inorganic light emitting material, or another material of similar properties.

10. The sensing apparatus according to claim 9, wherein the inorganic light emitting material comprises sodium iodide, cesium iodide, gadolinium oxysulfide, cadmium tungstate, bismuth germanium oxide, or glass.

11. The sensing apparatus according to claim 1, wherein at least one of the substrate of the first sensing device and the substrate of the second sensing device is a rigid substrate.

12. A sensing apparatus, comprising:
a first sensing device and a second sensing device, wherein the second sensing device is disposed on the first sensing device, and each of the first sensing device and the second sensing device comprises:
a substrate;
a sensor array, disposed on the substrate and comprising a plurality of sensing units; and
a scintillator layer, disposed on the sensor array,
wherein a pitch between two adjacent sensing units of the plurality of sensing units of the first sensing device is less than a pitch between two adjacent sensing units of the plurality of sensing units of the second sensing device.

13. The sensing apparatus according to claim 12, wherein a thickness of the scintillator layer of the second sensing device is different from a thickness of the scintillator layer of the first sensing device.

14. The sensing apparatus according to claim 12, further comprising a light shielding layer disposed between the first sensing device and the second sensing device.

15. The sensing apparatus according to claim 14, wherein a material of the light shielding layer comprises aluminum.

16. The sensing apparatus according to claim 12, wherein at least one of the substrate of the first sensing device and the substrate of the second sensing device is a flexible substrate.

17. The sensing apparatus according to claim 12, the plurality of sensing units comprising photodiodes.

18. The sensing apparatus according to claim 12, wherein the scintillator layer comprises an organic light emitting material, an inorganic light emitting material, or another material of similar properties.

19. The sensing apparatus according to claim 18, wherein the inorganic light emitting material comprises sodium iodide, cesium iodide, gadolinium oxysulfide, cadmium tungstate, bismuth germanium oxide, or glass.

20. The sensing apparatus according to claim 12, wherein at least one of the substrate of the first sensing device and the substrate of the second sensing device is a rigid substrate.
